(19) United States
(12) Patent Application Publication
(10) Pub. No.: US 2016/0267574 A1
(43) Pub. Date: Sep. 15, 2016

(54) PRODUCT DELIVERY CONFIGURATION PORTAL

(71) Applicant: Microsoft Technology Licensing, LLC, Redmond, WA (US)

(72) Inventors: Olga Turovceva Mulvad, Copenhagen (DK); Oleksandr Moskalyuk, Copenhagen (DK); Maciej Plaza, Copenhagen (DK); Roxana Christina Diaconu, Copenhagen (DK)

(21) Appl. No.: 14/800,303

(22) Filed: Jul. 15, 2015

Related U.S. Application Data
(60) Provisional application No. 62/130,166, filed on Mar. 9, 2015.

(51) Int. Cl. G06Q 30/06; G06F 3/0484

(52) U.S. Cl. CPC G06Q 30/0641; G06F 3/04847; G06F 3/04842; G06Q 30/0633

(57) ABSTRACT

A product delivery configuration portal includes a processor and a data store coupled to the processor. A user interface component is configured to generate a user interface providing order information relative to a sales order. The user interface has at least one flexibility selector that allows a variation of a parameter that affects product delivery. The user interface surfaces at least one delivery modification suggestion based on the sales order and a selection of the at least one flexibility selector. The user interface includes a user interface element that, when actuated, persists a delivery modification to the data store.

### CROSS-REFERENCE TO RELATED APPLICATION

The present application is based on and claims the benefit of U.S. provisional patent application Ser. No. 62/130,166, filed Mar. 9, 2015, the content of which is hereby incorporated by reference in its entirety.

### BACKGROUND

Manufacturers and distributers of goods strive to deliver goods ordered by a customer to the customer as soon as possible. The speed with which such goods arrive to a customer often forms part of the customer's impression of the manufacturer or distributor.

Establishing the earliest date when the ordered goods can reach the customer is a complex task requiring information from multiple sources, such as the current inventory levels, all the known future changes to these levels (e.g. sales, production, purchase orders already entered in the system), availability of raw materials for production, lead time for new purchase orders, available transportation methods, opening days and hours of the warehouses and transport companies involved, et cetera.

The discussion above is merely provided for general background information and is not intended to be used as an aid in determining scope.

### SUMMARY

A product delivery configuration portal includes a processor and a data store coupled to the processor. A user interface component is configured to generate a user interface providing order information relative to a sales order. The user interface has at least one flexibility selector that allows a variation of a parameter that affects product delivery. The user interface surfaces at least one delivery modification suggestion based on the sales order and a selection of the at least one flexibility selector. The user interface includes a user interface element that, when actuated, persists a delivery modification to the data store.

This Summary is provided to introduce a selection of concepts in a simplified form that are further described below in the Detailed Description. This Summary is not intended to identify key features or essential features of the claimed subject matter, nor is it intended to be used as an aid in determining the scope of the embodiments described herein.

### BRIEF DESCRIPTION OF THE DRAWINGS

FIG. 1 is a block diagram of one example of a computing environment in which embodiments described herein are particularly useful.

FIGS. 2A and 2B illustrate respective portions of a diagrammatic user interface allowing a user to select various parameters that affect delivery in accordance with one embodiment.

FIGS. 3A and 3B illustrate respective portions of a diagrammatic user interface allowing a user to select various parameters that affect delivery in accordance with another embodiment.

FIG. 4 is a flow diagram of a method of configuring product delivery in accordance with one embodiment.

FIG. 5 is a block diagram of a cloud-computing architecture with which embodiments described herein can be employed.

FIG. 6 provides a general block diagram of the components of a client device that can run an interactive delivery simulation in accordance with one embodiment.

FIG. 7 shows one embodiment using a tablet computer.

FIG. 8 provides an example of a smart phone that can be used with various embodiments described herein.

FIG. 9 is one embodiment of a computing environment in embodiments described herein can be deployed.

### DETAILED DESCRIPTION

Techniques and methods exist for taking available information into account when calculating the earliest delivery date under strict constraints, e.g. when the shipping warehouse and transportation method are predefined.

Previous attempts have exposed the necessary information for product delivery scheduling in a scattered way. For example, one electronic form on a display device of a computer system would be used to show a user the current inventory levels while another electronic form would be used to show the user how these levels are expected to change for a specific warehouse in the future. These forms would often lack any connection to the sales order for which product delivery is being arranged. For example, in order to estimate the transport time, the user would have to remember the customer's address and the warehouse from which the goods would be shipped and then, on a separate electronic form, enter these values in order to obtain. This made it difficult for the user to obtain an overview of the situation and arrive at a useful conclusion expeditiously.

Moreover, the scope, terminology and usability of the existing electronic forms that deal with availability and order promising details primarily target users with inventory management, requirement planning and/or material management expertise. However, the users who actually perform the task of order promising to customers would find such forms too overwhelming and/or complicated, and thus generally not particularly helpful for quickly finding the optimal delivery alternatives.

Some embodiments provided herein provide suggestions relative to how a better date can be obtained and expose all the information that may affect a shipping solution in an interactive way, allowing the user to obtain better insight into the possible solutions. Further, some embodiments allow a user to obtain an insight into why a specific date was calculated and what can be done to alter it if a customer is not satisfied with the initial estimate.

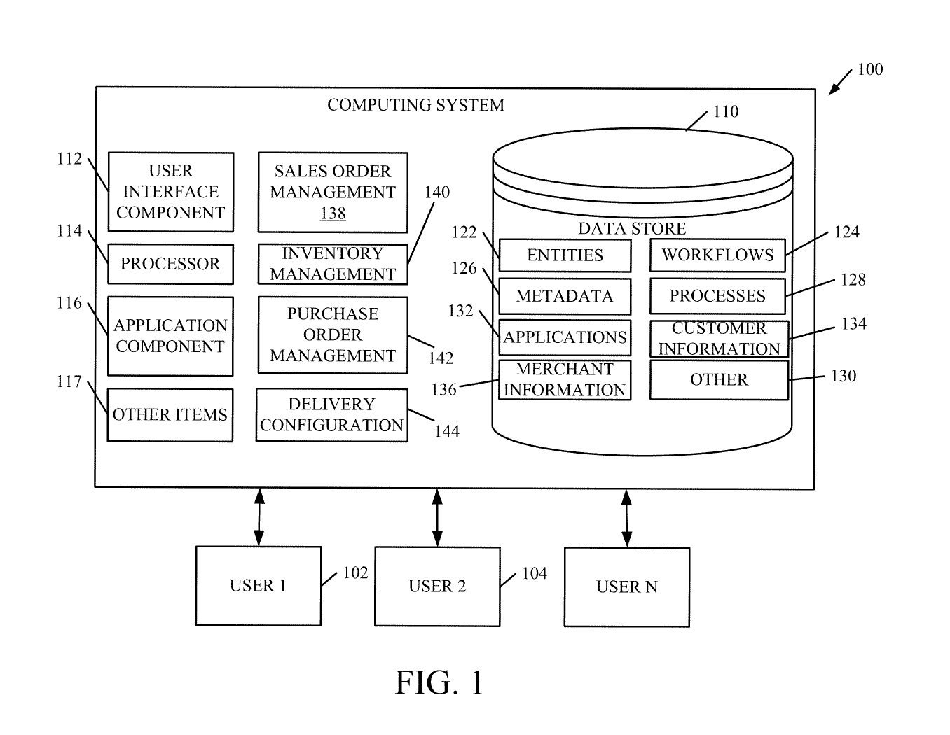

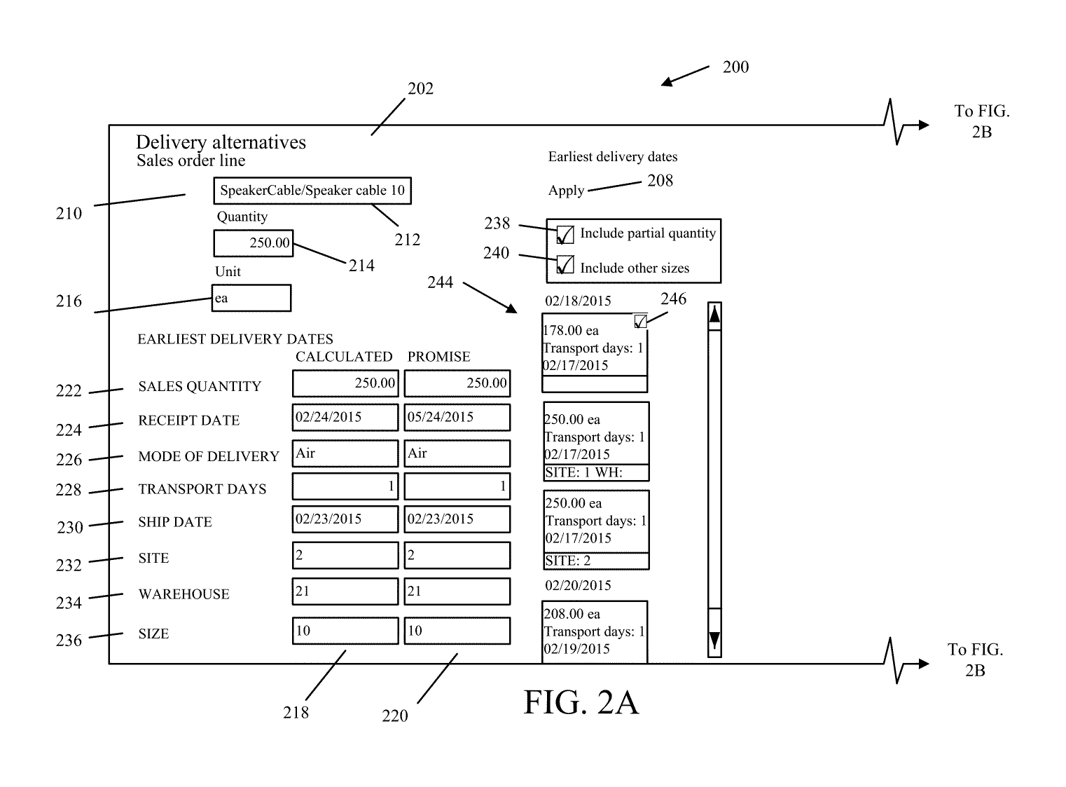

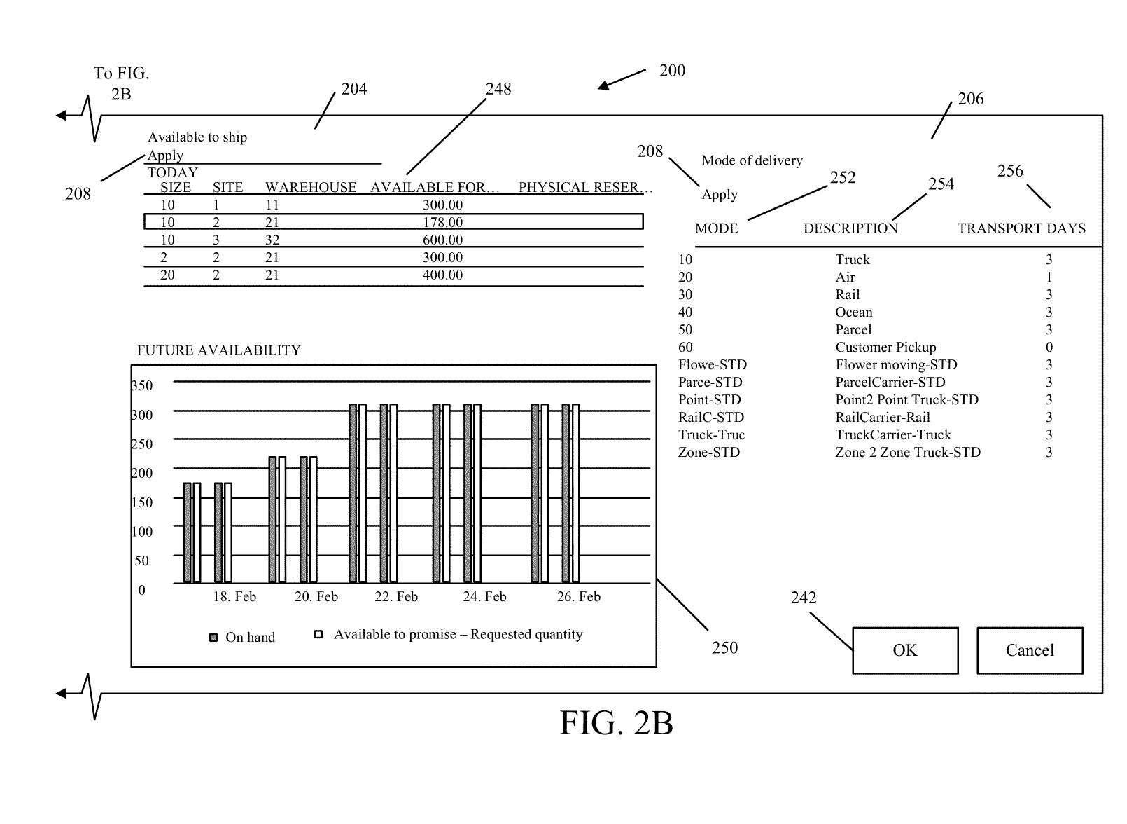

FIG. 1 is a block diagram of one example of a computing environment in which embodiments described herein are particularly useful. For example, each user can access computing system 100 locally or remotely. In one example, one or more users use a representative client device that communicates with computing system 100 over a wide area network, such as the internet. Users interact with user mechanisms to control and manipulate computing system 100. For instance, users can access data in data store 110. User data access can include, but is not limited to, read access, write access, and/or update access to the data. Updating data can include modifying and/or deleting data in data store 110. For sake of illustration, users 102 and 104 are shown accessing system 100 in FIG. 2. However, it is understood that any number of users can access system 100.

In the example shown in FIG. 1, computing system includes user interface component 112, at least one processor 114, and an application component 116. Computing system 100 can also include other items 117 as well.

Processor 114 is illustratively a computer processor with associated memory and timing circuitry (not shown). Processor 114 is illustratively a functional part of system 100 and is activated by, and facilitates the functionality of, other systems and components and items in system 100.

Data store 110, in one embodiment, includes data entities 122, workflows 124, processes 128, applications 132, customer information 134, and merchant information 136 that are implemented by application component 116 for users of computing system 100 to perform processes and tasks. Customer information 134 and merchant information 136 are useful when processing a sales order transaction or other type of order transaction. Processor 114 may allow a user to select data, such as data from customer information 134 and/or merchant information 136, in data store 110. In one embodiment, customer information 134 and merchant information 136 are made available to a user by displaying the information on a display.

Data store 110 may be a local data store of computing system 100, or may be, in one embodiment, at least partially implemented within a cloud storage subsystem. Information in data store 110 further includes metadata 126 and any other data 130 that can be used by application component 116 or other items in computing system 100. Entities 122, in one embodiment, describe entities within or otherwise used by system 100.

Computing system 100 can be any type of system that is accessed by users 102 and 104. In one example, but not by limitation, computing system 100 can comprise a scheduling system and/or an enterprise system. In one example, computing system 100 comprises a business system, such an enterprise resource planning (ERP) system, a customer resource management (CRM) system, a line-of-business system, or another business system. As such, applications 132 can be any suitable applications that may be executed by system 100 in order to perform one or more functions for which system 100 is deployed. Application component 116 accesses the information in data store 110 in implementing the programs, workflows, or other operations performed by the application component 116. For instance, application component 116, in one example, runs applications 132, which include workflows 124 and processes 128. Workflows 124 and processes 128, in one example, operate upon data entities 122 as well as other data 130 in order to enable the user to perform his or her operations within system 100. In one example, user interface component 112, either by itself or under the control of other systems in the system 100, generates user interface displays for the users.

User interface component 112 senses physical activities, for example, by generating user interface displays that are used to sense user interaction with computing system 100. The user interface displays can include user input mechanisms that sense user inputs in a wide variety of input actions, such as point and click devices (e.g., a computer mouse or track ball), a keyboard (either virtual or hardware), and/or a keypad. Further, where the display device used to display the user interface display is a touch sensitive display, the inputs can be provided as touch gestures. Similarly, the user inputs can illustratively be provided by voice inputs or other natural user interface input mechanisms as well.

As illustrated in FIG. 1, user interface component 112 is used by parts of system 100 generate user interface displays for users 102 and 104, respectively. In one example, one or more of user interface displays include user input mechanisms that receive inputs from the user for manipulating application component 116 or for manipulating and interacting with other items in computing system 100.

Computing system 100 also includes, in one embodiment, sales order management module 138, inventory management module 140, purchase order (PO) management module 142, and delivery configuration module 144. Sales order management module 138 provides, via user interface component 112, a user interface that facilitates the generation and processing of sales orders. Similarly, inventory management module 140 allows a user of computing system 100 to view data regarding individual items or groups of items in one or more inventories. Inventory management module 140 is typically used to create and process transfer orders to denote the flow or movement of inventory within a business or enterprise. PO management module 142 is used to create and/or process purchasing transactions. Sales order management module 138, inventory management module 140, and PO management module 142 are, in one embodiment, suitably programmed processing components. In one embodiment, a sales order, managed by sales order management module 138, is a transaction generally created by a user, such as user 102, 104 or order processor such that computing system 100 can document and track items or goods ordered by a customer. Sales order management module 138 can also track and/or document items or goods ordered by a customer through any suitable interaction with the enterprise, such as a customer a interacting with a user who is a sales person of the enterprise.

FIGS. 2A and 2B illustrate respective portions of a diagrammatic user interface allowing a user to select various parameters that affect delivery in accordance with one embodiment. Various embodiments described herein can be implemented on a suitable computing device by creating a user interface that shows comparisons between an original shipping solution and selections made by a user, together with the calculated delivery dates based on the user's selection. In one embodiment, form 200 is a portal that includes multiple columns 202, 204, 206 where column 202 contains a side by side comparison of the original sales order details and the selections made by the user, together with the calculated delivery dates. The next columns 204, 206 contain options for controlling flexibility, including an option to ship a lower quantity than initially ordered and options for enabling or disabling changes to specific product attributes. Only the attributes that apply to the ordered product would get displayed in this column. Below, a list of suggestions 244 is calculated based on these restrictions. The suggestions 244 highlight the delivery date they offer and the necessary changes to the order. In a first suggestion, a potential delivery date of Feb. 18, 2015 is provided by shipping quantity 178 of SpeakerCable10 instead of the original 250 quantity. Other potential delivery configurations are shown below the February 18th suggestion. As further shown in FIG. 2A, portal 200 specifically recommends the partial shipping of 178 items as indicated by checkbox 246. Once the user selects a suggestion and clicks the “apply” button 208, the simulated data gets updated and the user can see the impact immediately.

As shown in FIG. 2A, column 202 sets forth a number of delivery parameters. Specifically, a sales order line region 210 is provided that shows a number of details of the original order. For example, field 212 provides a description of the item ordered “SpeakerCable/Speaker cable 10”, while field 214 provides a quantity of the item ordered “250.00.” Finally, field 216 illustrates the type of quantity. For example, field 216 shows a type of “ea” meaning that 250 individual items of Speaker cable 10 were ordered. Column 202 also includes a calculated sub-column 218 and a promise sub-column 220. In each of sub-columns 218 and 220, a number of rows are provided illustrating specific details with respect to the delivery. As shown, a sales quantity row 222 indicates the quantity for each of calculated column 218 and promise 220. Additionally, a receipt date 224 row is provided that shows a receipt date for both calculated column 218 and promise column 220. Further, a mode of delivery row 226 is provided that specifies the mode of delivery for both calculated column 218 and promise column 220. A transport days row 228 is provided illustrating the number of transport days associated with the mode of delivery set forth in the mode selected in row 226. A ship date row 230 is provided indicating the ship date for both calculated column 218 and promise column 220. The site from which the item ships is provided in row 232 for each of calculated column 218 and promise column 220. Further, the warehouse is indicated in row 234 relative to both calculated column 218 and promise column 220. Finally, the size of the product is indicated in size row 236 for each of columns 218 and 220.

As shown in FIG. 2A, column 202 includes a plurality of selectable flexibility selectors that allow the user to surface and/or suggest potential delivery modifications. For example, item 238 allows a user to select whether partial quantities will be allowed by the customer. For example, if a customer has ordered 250 units of particular item, and the order will only ship when all 250 units are available, the shipment may be delayed if the on hand inventory is only 200 units. Accordingly, if item 238 checked, the user may configure the order to ship the partial quantity of 200 items and ship the remaining 50 items when they become available. In this way, the customer need not wait for all items to become available before the entire shipment arrives.

Column 202 also shows another flexibility selector at reference number 240 that indicates whether other sizes may potentially be accepted by the customer. For example, if a customer has ordered SpeakerCable size 10, and would accept SpeakerCable size 9, it may be possible to fulfill the order more quickly by providing SpeakerCable size 9 instead of waiting for a sufficient quantity of SpeakerCable size 10 to become available. Flexibility selectors 238 and 240 are examples of user interface elements that may be selected or deselected by a user of portal 200 in order to interact with and/or observe variables that affect product delivery. Moreover, in one embodiment, the user of portal 200 may make multiple changes with respect to a number of delivery configuration without persisting or otherwise storing changes to the order. In this way, the user can perform “what-if” simulations which respect to product delivery. Then, if a particular product delivery configuration meets with the customer's approval, the particular configuration can be persisted to system 100 by pressing or otherwise engaging “OK” button 242 (shown in FIG. 2B).

Column 204 is shown in FIG. 2B and provides detailed information which respect to current and future inventory levels relative to the selected order. Column 204 indicates a current inventory in area 248, and a future availability in area 250. As shown in area 248, a number of different sizes are shown at various sites and warehouses. Further, the specific number of items for each size is listed for each site and warehouse. This allows the user quickly identify potential sources for shipping more effectively and/or partial quantities to the customer. Further, future availability portion 250 also helps the user understand the potential impact of any changes to the order on future inventory levels. Selecting any record and clicking “apply” instantly updates the simulated outcome with the new values. Clicking on the inventory levels for a specific date opens a dialog form showing all the transactions that affect the inventory levels for the selected day.

Column 206 contains a list of all the possible modes of transportation together with the delivery time for each of possible mode, considering the shipping warehouse selected in any of the previous steps and the customer's address. As shown in FIG. 2B, column 206 includes a listing of the various modes of delivery in sub-column 252 as well as a description thereof in sub-column 254. Further, a number of transport days for each respective mode of delivery is illustrated in sub-column 256. Thus, the user of portal 200 can see differences in the different modes of delivery and can click on or otherwise select one of the modes of delivery and select “apply” button 208 to update the simulation with the selected mode of delivery. In the event that the user wishes to change to a different of mode of delivery, the different mode of delivery can simply be selected and the user can select “apply” button 208 again in order to switch the simulation to the newly-selected mode of delivery. Finally, when the customer is satisfied with the simulated results, the user can select “OK” button 242 to confirm the selections and transfer the simulated data into the actual sales order.

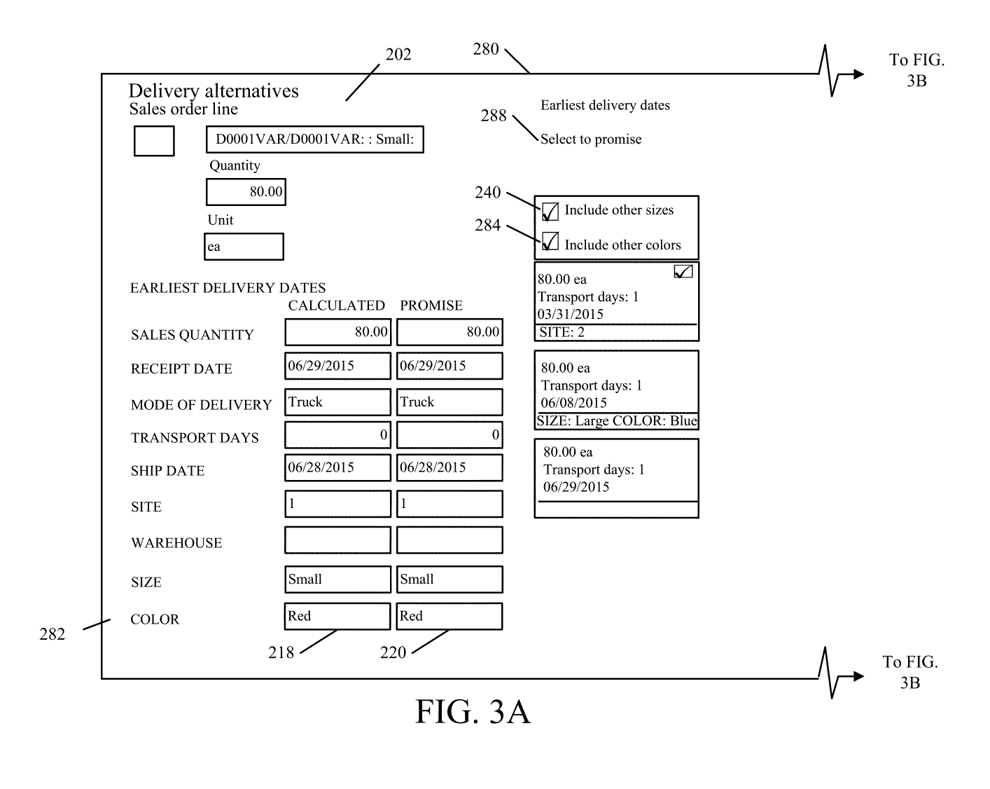

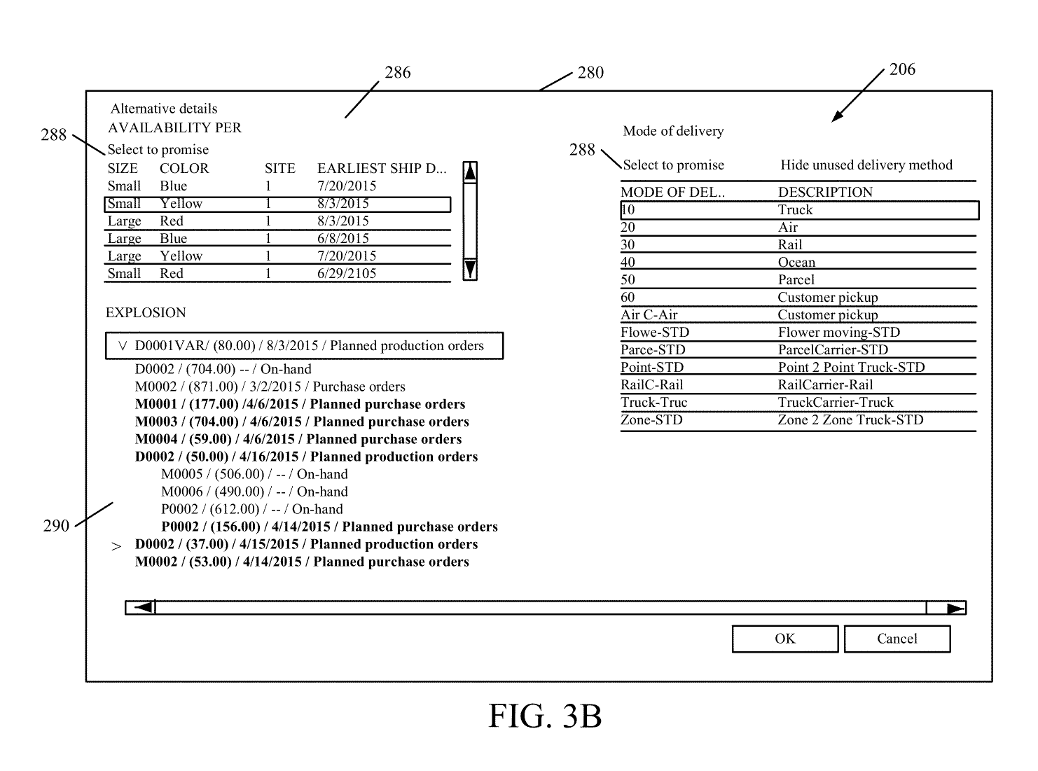

FIGS. 3A and 3B illustrate respective portions of a diagrammatic user interface allowing a user to select various parameters that affect delivery in accordance with another embodiment. Portal 280 bears many similarities to portal 200 described with respects to FIGS. 2A and 2B, and like components are numbered similarly. Specifically, portal 280 includes first column 202 that provides a number of fields relative to a sales order. Like the embodiment described with respect to FIGS. 2A and 2B, column 202 includes sub-columns 218 and 220. However, column 202 also includes a color row 282 that indicates a color of the purchased item. In the example shown, the color is “Red.” Contrasting the embodiment shown in FIGS. 3A, 3B with that of FIGS. 2A and 2B, it is apparent that the information tracked relative to sales orders may vary in different applications. Further still, information tracked relative to the sales order may vary based on the item itself. For example, if all configurations of a particular item are of the same color, then color row 282 need not be displayed. However, if different versions of the product have different power requirements, an additional row indicating the various power requirements of the product may be set forth in a row of the order line in column 204. Flexibility selectors 240 and 284 allow various delivery options relative to potentially different products to be surfaced. As shown FIG. 3A, checkbox 240 allows the surfacing of items that are of a different size than those of the subject order. Similarly, selector 284 is checked allowing the surfacing of products that have a different color than the products ordered in the sales order. For each respective row in columns 218, 220 that indicates characteristics of the product, embodiments described herein may include flexibility selectors such as, selectors 240, 284, that allow variations in the product of these specified variables.

Portal 280 also includes alternative details section 286 that lists alternative details with respect to products of various sizes and colors. In the example shown in FIG. 3B, each combination of size and color has a designated earliest ship date at which that particular product configuration may be shipped. Additionally, alternative details section 286 also includes explosion portion 290 that lists additional details with respect to the particular product. Such details may include the number of items on hand, purchase orders generated in the past, purchase planned for the future, or any other potentially relevant information relative to the selected items. Additionally, while the embodiment described with respect to FIGS. 2A and 2B lists a number of “apply” buttons 208, portal 280 includes a number of “select to promise” user interface elements 288 that allow the user thereof, upon actuation, to cause the information selected by the user to be migrated into promise column 220 for contrasting with information set forth in calculated column 218.

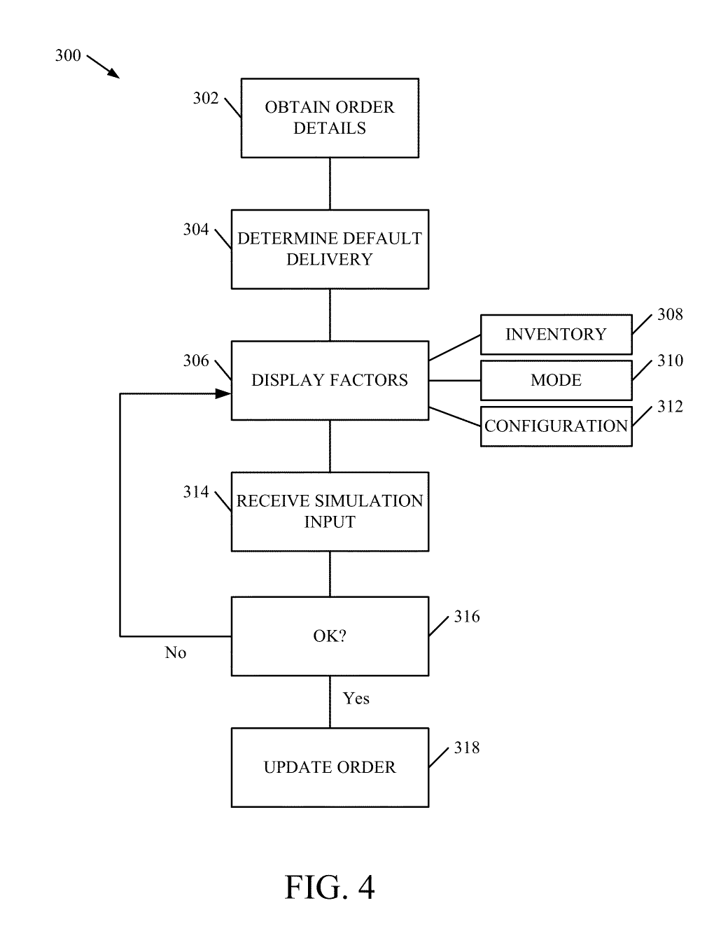

FIG. 4 is a flow diagram of a method of configuring product delivery in accordance with one embodiment. Method 300 begins at block 302 where order details are obtained by a computing system, such as computing system 100. This, may be in the form of a user entering order details during the process of order entry, or a user choosing to access and modify an existing sales order. Next, at block 304, a default delivery configuration is generated by the computing system based on initial configuration information. For example, the default delivery may include a calculation of the amount of time to obtain or otherwise have the full amount of the order on hand before it is delivered to the customer. Further, a default delivery mode, such as truck, may be employed to determine how long it will take once sufficient product is on hand for the product to be delivered from a relevant site and/or warehouse to the address of the customer. Next, at block 306, the default delivery is indicated to a user via a display using a user interface component, such as user interface component 112. Additionally, various parameters that may affect the delivery date can be shown to user. These parameters may include inventory level 308, both current and future, delivery mode information 310, and product configuration details 312. Next, at block 314, the computing system receives a user simulation input. For example, the user may generate a simulation input by switching from the default delivery of truck to “air.” Then, the system, when so commanded, will update the delivery information displayed to show the effect of the simulated input. For example, the air delivery will typically require less time than truck delivery and thus the impact of the faster delivery will be shown on the potential delivery date. Additional simulation inputs can include a selection or deselection of delivery flexibility user interface elements, such as elements 238, 240, and 284. Next, at block 316, method 300 determines whether the user has accepted the information entered in the simulation. This is generally provided by a user selecting “OK” button 242 to indicate to the system that the customer has accepted the revised delivery configuration. If such revised delivery configuration has been accepted, method 300 passes to block 318 where the sales order is updated with the revised delivery information and stored or otherwise persisted in the computing system. In the event that the user has not accepted the simulated configuration, control returns to block 306 where the simulated delivery configuration continues to be displayed to the user and will allow the user to make additional delivery configuration changes.

Alternative implementations can use different ways of calculating the suggested solutions or change the layout of the user interface. For example, columns can be reordered, the options for restricting flexibility can be implemented as selecting one of a few predefined values instead of a set of checkboxes, specific columns can be hidden and shown on demand if the more general information is not sufficient.

Embodiments described herein may provide a number of useful features to users. Generally, such features provide some form of interactive visualization of delivery promising possibilities to a user. In some instances, an automatically-calculated set of suggestions that include changes to the initial order and their impact on the delivery date are provided. The suggestions can include, for example, changing the warehouse from which the goods would be shipped, some attributes of the ordered product (e.g. color or size) or reducing the shipped quantity. Additionally, various options can be selected or deselected to define a level of flexibility when searching for alternative solutions. For example, a customer may require that a specific size of the ordered product is needed, but the color may be allowed to change Additionally, some embodiments may provide the user with an overview of the current inventory levels for the ordered goods. The level of detail can depend on the allowed flexibility, for example inventory levels would be displayed for all the colors, but only the specific size that the customer needs. In some embodiments, a chart or other graphical representation of future inventory levels may be provided to the user for the selected product attributes and physical locations. Further, a list of possible transport modes, including automatic calculation of the transport time between the selected warehouse and customer's address may also be provided. Further still, an option to view what other orders affect the inventory levels may also be provided to the user. Finally, embodiments described herein include various combinations of the showing and/or changing different aspects of an order that relate to delivery.

The improved aggregation of many aspects that can affect delivery into an efficient portal allows a user to more effectively interact with a customer when a solution to a delivery problem is sought. The impact of various changes to the delivery of the order can be simulated such that the interaction between the user and the customer is more efficient. Moreover, when a solution is found that meets with the customer's approval, the sales order can be updated automatically, without requiring the user to re-enter any additional information. This reduces the efforts required by the user and also reduces the potential for errors to be introduced into the system. As can be appreciated, if an error is introduced into the system after the customer has specifically sought an improved delivery solution, the customer's impression of the merchant or distributor could be seriously harmed.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

The embodiments of the system described herein can leverage various data in one or more data stores in order to depict various items that affect delivery. It will be noted that the various data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

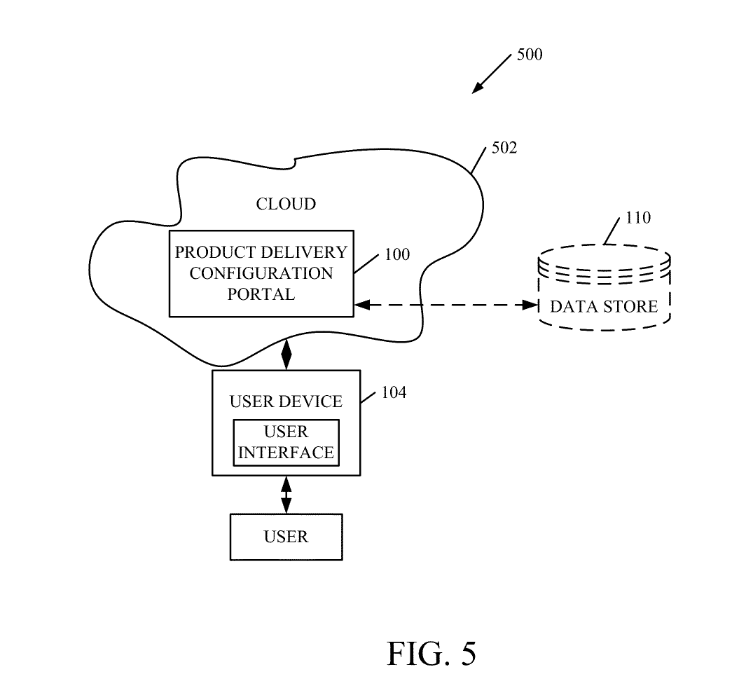

FIG. 5 is a block diagram of a cloud computing architecture 500 with which various embodiments described herein are useful. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, et cetera.

FIG. 5 shows that product delivery configuration portal 100 can be located in cloud 502 (which can be public, private, or a combination where portions are public while others are private). Therefore, a user uses a device 104 to access system 100 through cloud 502.

FIG. 5 also depicts another embodiment of a cloud architecture. FIG. 5 shows that it is also contemplated that some elements of product delivery configuration portal 100 are located in cloud 502 while others are not. By way of example, data store 110 is located outside of cloud 502, and accessed through cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 500, or portions of it, can be implemented on a wide variety of different devices. Some of those devices include servers, desktop computers, laptop computers, tablet computers, or other mobile devices, such as palm top computers, cell phones, smart phones, multimedia players, personal digital assistants, et cetera.

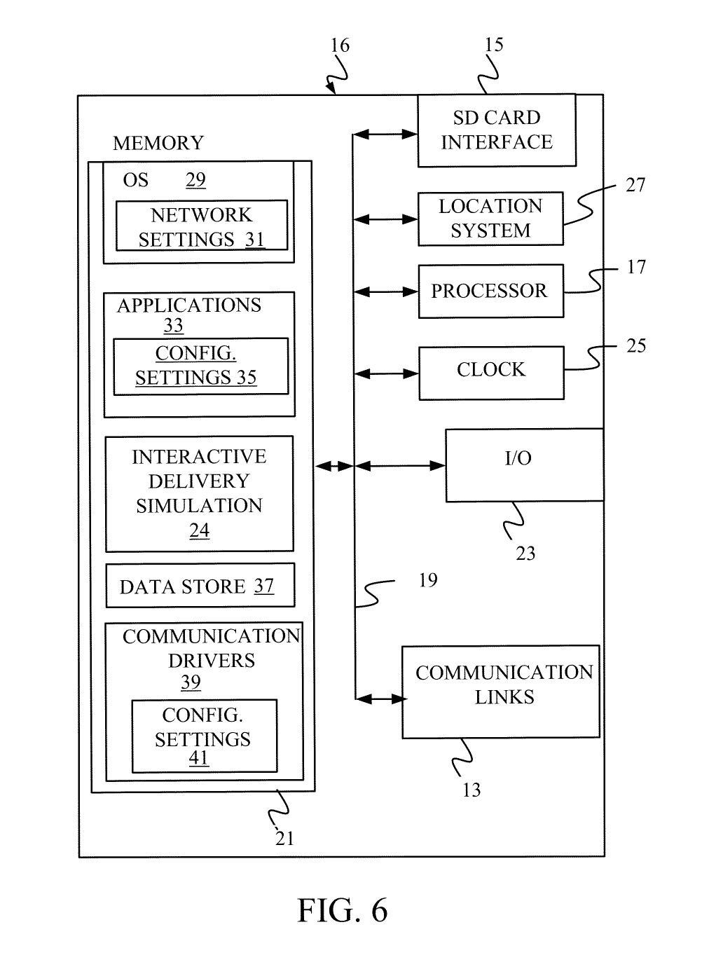

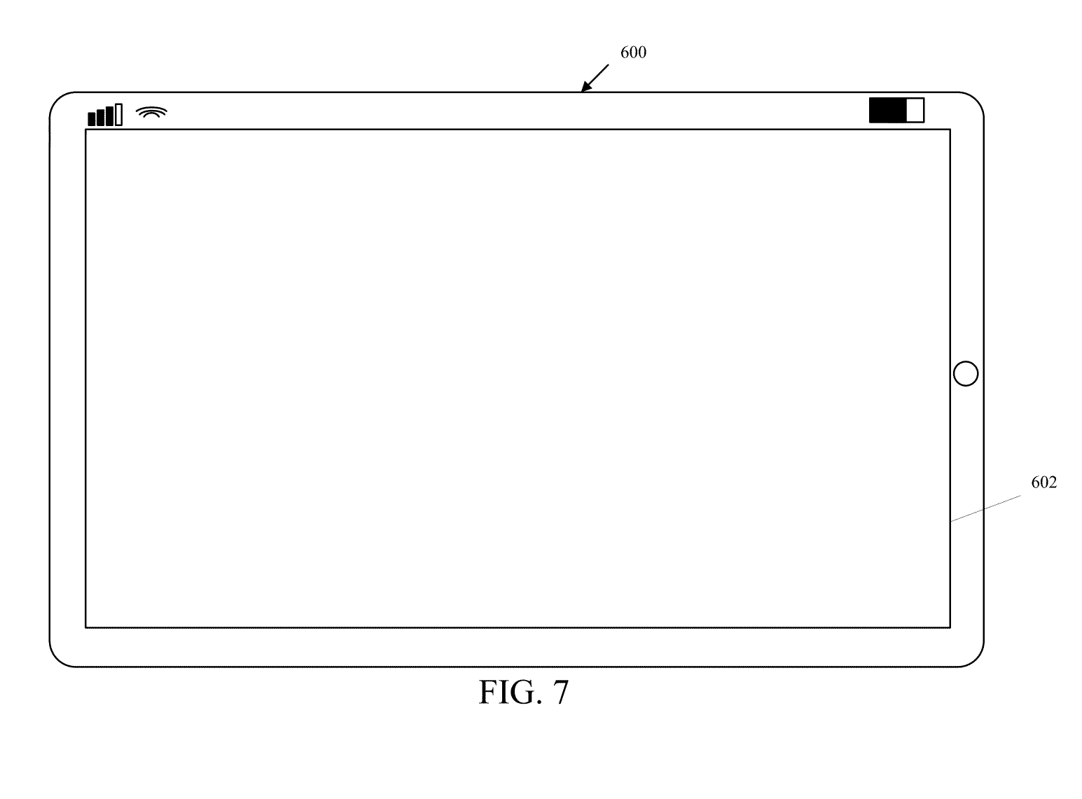

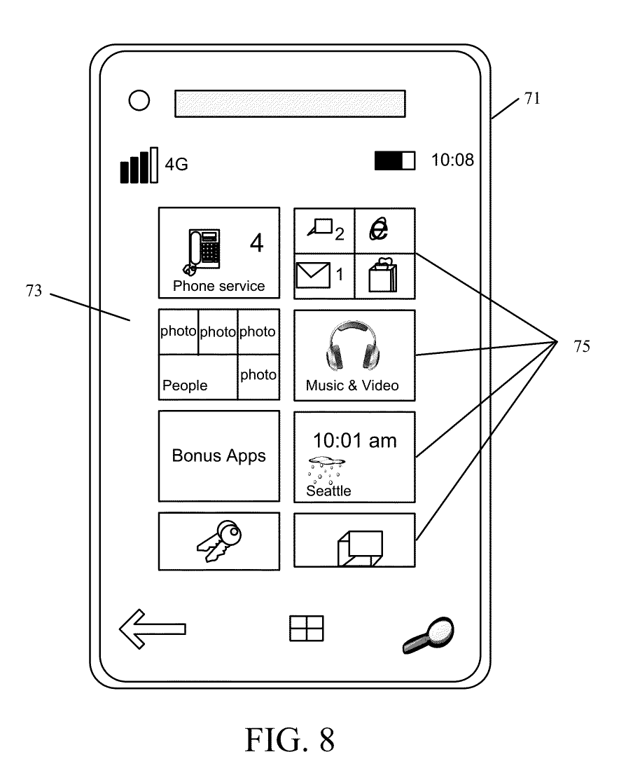

FIG. 6 is a simplified block diagram of one illustrative embodiment of a handheld or mobile computing device that can be used as a user's hand held device 16, in which embodiments described herein (or parts of it) can be deployed. FIGS. 7-8 are examples of handheld or mobile devices.

FIG. 6 provides a general block diagram of the components of a client device 16 that can run components of product delivery configuration portal 100. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Product delivery simulation application 24, or client-side portions of system 100 (shown in FIGS. 2A, 2B, 3A, and 3B), for example, can reside in memory 21.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with a display screen 602 that is suitable for displaying various user interfaces in accordance with embodiments described herein. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 8 is illustrates another mobile device on which embodiments described herein can be practiced. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

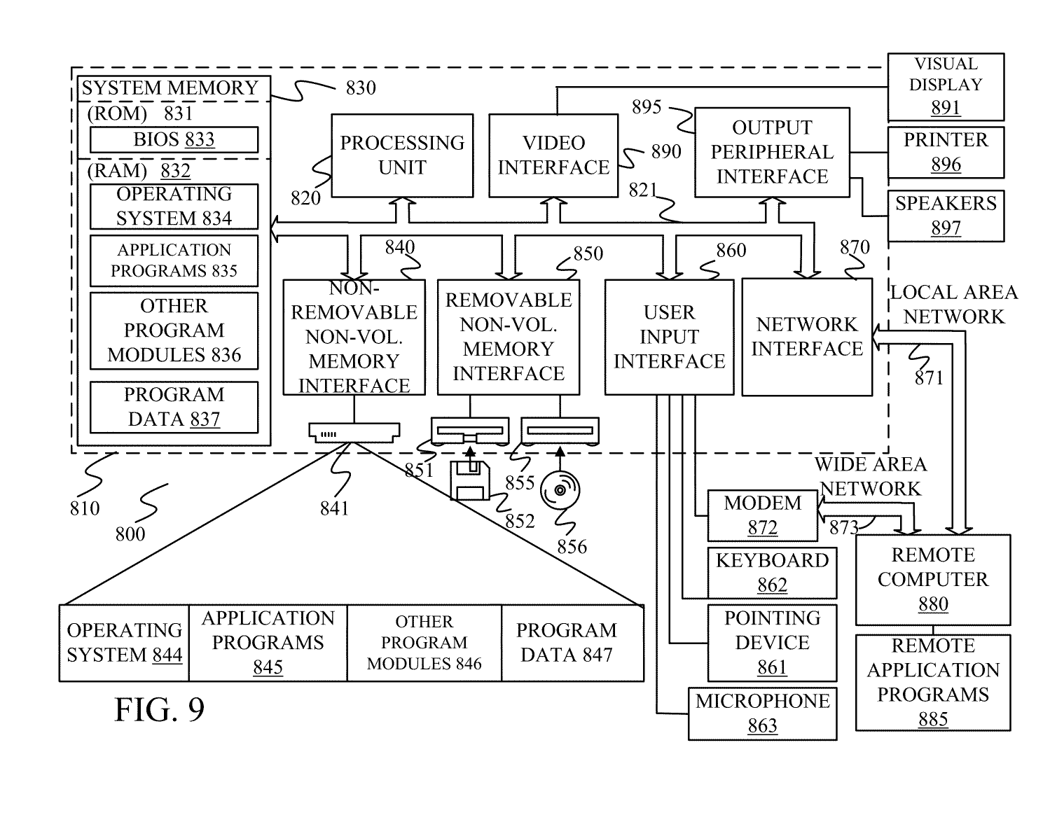

FIG. 9 is an example of a computing environment suitable for implementing product delivery configuration portal 100 or portions thereof. With reference to FIG. 9, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described herein can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), et cetera.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a product delivery configuration portal that includes a processor and a data store coupled to the processor. A user interface component is configured to generate a user interface providing order information relative to a sales order. The user interface has at least one flexibility selector that allows a variation of a parameter that affects product delivery. The user interface surfaces at least one delivery modification suggestion based on the sales order and a selection of the at least one flexibility selector. The user interface includes a user interface element that, when actuated, persists a delivery modification to the data store.

Example 2 is the product delivery configuration portal of any or all previous examples wherein the at least one flexibility selector includes a plurality of flexibility selectors each selecting a different parameter that affects product delivery.

Example 3 is the product delivery configuration portal of any or all previous examples wherein the user interface includes a user interface element that, when actuated, updates a delivery simulation without persisting a delivery modification to the data store.

Example 4 is the product delivery configuration portal of any or all previous examples wherein the at least one flexibility selector is a Boolean element having two states.

Example 5 is the product delivery configuration portal of any or all previous examples wherein the Boolean element is a check box.

Example 6 is the product delivery configuration portal of any or all previous examples wherein the user interface includes a plurality of columns each having a different type of information that affects product delivery.

Example 7 is the product delivery configuration portal of any or all previous examples wherein a first column includes sales order information.

Example 8 is the product delivery configuration portal of any or all previous examples wherein the first column also includes the at least one flexibility selector.

Example 9 is the product delivery configuration portal of any or all previous examples wherein the first column includes the at least one delivery modification suggestion.

Example 10 is the product delivery configuration portal of any or all previous examples wherein a second column includes inventory information relative to the sales order.

Example 11 is the product delivery configuration portal of any or all previous examples wherein the inventory information includes current inventory information.

Example 12 is the product delivery configuration portal of any or all previous examples wherein a level of detail displayed in the second column is determined by at least one flexibility selector.

Example 13 is the product delivery configuration portal of any or all previous examples wherein the inventory information displays information relative to at least one different order that affects delivery of the sales order.

Example 14 is the product delivery configuration portal of any or all previous examples wherein the inventory information includes future inventory information.

Example 15 is the product delivery configuration portal of any or all previous examples wherein a third column includes delivery mode information.

Example 16 is the product delivery configuration portal of any or all previous examples wherein a third column includes an alternative details portion providing additional details with respect to at least one item of the sales order.

Example 17 is a computer-implemented method of configuring product delivery. The method includes accessing a sales order and generating a default delivery relative to the sales order. Information indicative of the default delivery is displayed to a user via a user interface component of a computer. A simulation input is received and an effect of the simulation input on product delivery in comparison to the default delivery is displayed. Upon receiving acceptance of the simulation, persisting the simulation.

Example 18 is the computer-implemented method of any or all previous examples wherein accessing the sales order includes entering a new sales order.

Example 19 is the computer-implemented method of any or all previous examples wherein accessing the sales order includes retrieving information regarding an existing sales order.

Example 20 is a product delivery configuration portal that includes a processor and memory coupled to the processor. The memory stores instructions which, when executed by the processor, cause the processor to execute a client-side application that interacts with a sales order computing system. The client application provides a user interface that presents order information relative to a sales order. The user interface has at least one flexibility selector that allows a variation of a parameter that affects product delivery. The user interface surfaces at least one delivery modification suggestion based on the sales order and a selection of the at least one flexibility selector. The user interface includes a user interface element that, when actuated, persists a delivery modification.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A product delivery configuration portal comprising:
a processor;
a data store coupled to the processor;
a user interface component configured to generate a user interface providing order information relative to a sales order, the user interface having at least one flexibility selector that allows a variation of a parameter that affects product delivery;
wherein the user interface surfaces at least one delivery modification suggestion based on the sales order and a selection of the at least one flexibility selector; and
wherein the user interface includes a user interface element that, when actuated, persists a delivery modification to the data store.

2. The product delivery configuration portal of claim 1, wherein the at least one flexibility selector includes a plurality of flexibility selectors each selecting a different parameter that affects product delivery.

3. The product delivery configuration portal of claim 1, wherein the user interface includes a user interface element that, when actuated, updates a delivery simulation without persisting a delivery modification to the data store.

4. The product delivery configuration portal of claim 1, wherein the at least one flexibility selector is a Boolean element having two states.

5. The product delivery configuration portal of claim 4, wherein the Boolean element is a check box.

6. The product delivery configuration portal of claim 1, wherein the user interface includes a plurality of columns each having a different type of information that affects product delivery.

7. The product delivery configuration portal of claim 6, wherein a first column includes sales order information.

8. The product delivery configuration portal of claim 6, wherein the first column also includes the at least one flexibility selector.

9. The product delivery configuration portal of claim 6, wherein the first column includes the at least one delivery modification suggestion.

10. The product delivery configuration portal of claim 6, wherein a second column includes inventory information relative to the sales order.

11. The product delivery configuration portal of claim 10, wherein the inventory information includes current inventory information.

12. The product delivery configuration portal of claim 10, wherein a level of detail displayed in the second column is determined by at least one flexibility selector.

13. The product delivery configuration portal of claim 10, wherein the inventory information displays information relative to at least one different order that affects delivery of the sales order.

14. The product delivery configuration portal of claim 10, wherein the inventory information includes future inventory information.

15. The product delivery configuration portal of claim 10, wherein a third column includes delivery mode information.

16. The product delivery configuration portal of claim 10, wherein a third column includes an alternative details portion providing additional details with respect to at least one item of the sales order.

17. A computer-implemented method of configuring product delivery, the method comprising:
accessing a sales order;
generating a default delivery relative to the sales order;
displaying information indicative of the default delivery to a user via a user interface component of a computer;
receiving a simulation input and displaying an effect of the simulation input on product delivery in comparison to the default delivery; and
upon receiving acceptance of the simulation, persisting the simulation.

18. The computer-implemented method of claim 17, wherein accessing the sales order includes entering a new sales order.

19. The computer-implemented method of claim 17, wherein accessing the sales order includes retrieving information regarding an existing sales order.

20. A product delivery configuration portal comprising:
a processor;
memory coupled to the processor and storing instructions which, when executed by the processor, cause the processor to execute a client-side application that interacts with a sales order computing system, the client application providing a user interface that presents order information relative to a sales order, the user interface having at least one flexibility selector that allows a variation of a parameter that affects product delivery;
wherein the user interface surfaces at least one delivery modification suggestion based on the sales order and a selection of the at least one flexibility selector; and
wherein the user interface includes a user interface element that, when actuated, persists a delivery modification.
